(19) United States
(12) Patent Application Publication
(10) Pub. No.: US 2023/0162483 A1
(43) Pub. Date: May 25, 2023

(54) AN ELECTRONIC DEVICE AND RELATED METHOD FOR OBJECT DETECTION

(71) Applicant: Sony Group Corporation, Tokyo (JP)

(72) Inventor: Hannes BERGKVIST, Helsingborg (SE)

(21) Appl. No.: 17/919,300

(22) PCT Filed: Mar. 15, 2021
(86) PCT No.: PCT/EP2021/056520

§ 371 Date: Oct. 17, 2022

(30) Foreign Application Priority Data
May 7, 2020 (SE) 2050537-6

(51) Int. Cl. G06V 10/774; G06V 10/26; G06V 10/22; G06V 10/98; G06V 10/776; G06V 10/94

(52) U.S. Cl. CPC G06V 10/774; G06V 10/95; G06V 10/98; G06V 10/235; G06V 10/267; G06V 10/776

(57) ABSTRACT

The present disclosure provides an electronic device. The electronic device comprises a memory circuitry, an interface circuitry, and a processor circuitry. The processor circuitry is configured to obtain first image data associated with a first image. The processor circuitry is configured to obtain a primary object based on the first image data. The processor circuitry is configured to generate one or more secondary objects based on a first augmentation operation of the primary object. The processor circuitry is configured to obtain primary background data from the first image data. The processor circuitry is configured to generate secondary background data based on a second augmentation operation of the primary background data. The processor circuitry is configured to provide a first data set by combining the primary object and/or the one or more secondary objects with the primary background data and/or the secondary background data.

The present disclosure pertains to the field of image processing. The present disclosure relates to an electronic device and a method for object detection.

### BACKGROUND

There are many scenarios where electronic devices (such as smartphones and camera devices) are used to take pictures (such as images, sequence of images, or videos) of objects. Further, some electronic devices make use of image processing technology for detecting objects in images. However, there is room for improvement of the existing image processing technology for detecting objects in images.

### SUMMARY

Existing electronic devices and methods may comprise mechanisms for object detection in image data. However, object detectors may not be optimal across ranges or types of objects. Object detectors are either too generic or specifically dedicated to detecting predefined or preselected types of objects. For example, a face detector may be able to detect the predefined or preselected type of object which is a face. Generic object detectors do not provide sufficient accuracy in detecting specific objects, while the dedicated object detector can solely detect predefined or preselected types of objects. Existing object detectors are not capable of learning from detections to improve the detection of objects of various types. There is a need for a technique for allowing an object detector to learn and adapt the detection to the type of object. There is a need for providing adaptability and learning of the detection and improving accuracy of detection.

Accordingly, there is a need for electronic devices and methods for object detection, which mitigate, alleviate or address the shortcomings existing and provide an improved object detection (such as an improved performance object detection), with improved automated image augmentation, improved labelling of images, and custom object detection. Further, there is a need for improving use of functionalities of the electronic device acquiring the images (for example a camera or video camera, such as acquiring sequences of images, such as videos) based on feedback from the object detector.

The present disclosure provides an electronic device. The electronic device comprises a memory circuitry, an interface circuitry, and a processor circuitry. The processor circuitry is configured to obtain first image data associated with a first image. The processor circuitry is configured to obtain a primary object based on the first image data.

The processor circuitry is configured to generate one or more secondary objects based on a first augmentation operation (such as comprising one or more augmentation operations, for example a series of augmentation operations) of the primary object.

The processor circuitry is configured to obtain primary background data from the first image data. The processor circuitry is configured to generate secondary background data based on a second augmentation operation (such as comprising one or more augmentation operations, for example a series of augmentation operations) of the primary background data.

The processor circuitry is configured to provide a first data set by combining the primary object and/or the one or more secondary objects with the primary background data and/or the secondary background data. The processor circuitry is configured to generate, based on the first data set, a detection model for detecting one or more objects of the same type as the primary object. The processor circuitry is configured to provide an object detector configured to detect, based on the detection model, the one or more objects.

Further, a method, performed by an electronic device, for object detection, is provided. The method comprises obtaining first image data associated with a first image.

The method comprises obtaining a primary object based on the first image data.

The method comprises generating one or more secondary objects based on a first augmentation operation (such as comprising one or more augmentation operations, for example a series of augmentation operations) of the primary object. The method comprises obtaining primary background data from the first image data. The method comprises generating secondary background data based on a second augmentation operation (such as comprising one or more augmentation operations, for example a series of augmentation operations) of the primary background data. The method comprises providing a first data set by combining the primary object and/or the one or more secondary objects with the primary background data and/or the secondary background data. The method comprises generating, based on the first data set, a detection model for detecting one or more objects of the same type as the primary object. The method comprises providing an object detector configured to detect, based on the detection model, the one or more objects.

It is an advantage of the present disclosure to enable a user to add specific objects to be detected so as to provide an object detector for detection of the specific objects (such as interactively working towards creating an object detector for that/these particular objects with an improved performance). In other words, an advantage of the present disclosure is to provide an object detector capable of detecting one specific object (such as a user specific object that a user may be interested in capturing in the future) when using the electronic device. Further, an advantage of the present disclosure is that an improved object detector is provided for custom object detection (such as specialized or personalized for the user, for example custom for a user object, such as a dog of the user). In turn, an improved object detector is provided, for example detecting a specific object (such as a specific dog of the user) and not only a generic object (such as a generic dog detector). An advantage may be that the images produced may be improved by recognizing objects (such as subjects) in the same way that a camera changes behavior when a face is recognized.

Further, an advantage of the present disclosure is that the user may be provided with feedback such as regarding the quality of the images provided to the detection model, for example for improving a camera focus (such as when capturing images and/or videos), adjusting a brightness, for improving the specific object detection.

A further advantage of the present disclosure is that the number of combinations of objects and backgrounds (such as using one or more augmentation operations) may be enlarged (for example by using statistical properties of the background of labelled images and finding similar images, to use as input in the background augmentation operation). Further, an advantage of the present disclosure is that substantially any objects may be detected in substantially any environments (such as the detection model may learn to detect any objects in substantially any environments). Further, an advantage of the present disclosure is that the labelling of the images may be improved (such as providing metadata, for example related to camera parameters and/or object field).

It may be appreciated that the present disclosure provides an automatic detection model performance analysis (such as providing user interface improvement instructions). Further, the present disclosure provides an electronic device capable of assisting the use in performing the technical task of operating in an improved manner the object detector, for example by providing an object detection selector in the electronic device user interface.

Further, an advantage of the present disclosure is that the electronic device may support the user in taking better pictures (for example by providing feedback to the user for utilizing better, more appropriate or more features of the camera) and providing improved image data for the detection model (such as for improving the detection model).

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1 is a schematic representation illustrating an example of a scenario according to one or more embodiments of this disclosure,

FIG. 2 is a schematic representation illustrating an example of a scenario of object detection showing a system comprising a block diagram illustrating an electronic device according to the disclosure acting as a server device and a block diagram illustrating an electronic device according to the disclosure acting as a user device,

FIGS. 3A, 3B, 3C, and 3D are flow-charts illustrating an example method, performed by an electronic device, for object detection, according to this disclosure, and

FIGS. 4A-B shows examples of user interfaces of an electronic device acting as a user device according to the present disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

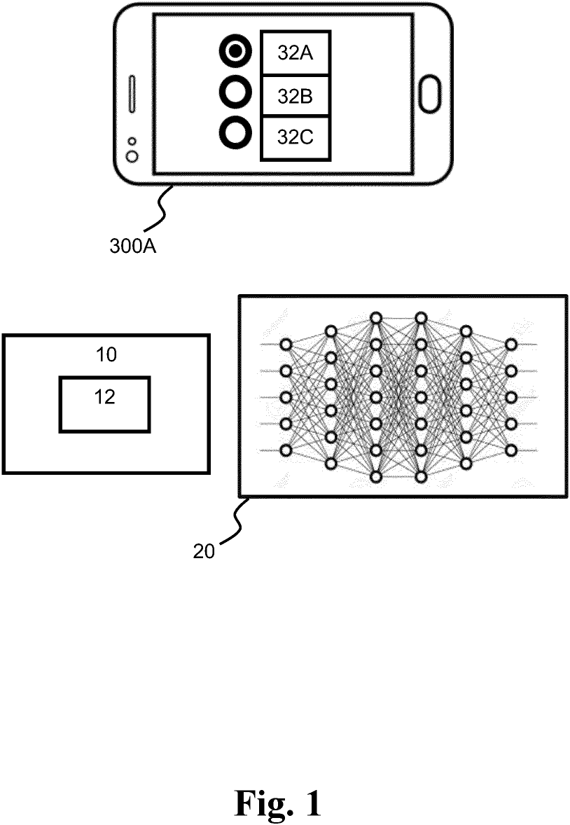

FIG. 1 is a schematic representation illustrating an example of a scenario according to one or more embodiments of this disclosure. FIG. 1 illustrates an example custom object detection with an automated image augmentation and generation according to one or more embodiments of this disclosure.

For example, a user (such as a person, for example a photographer) of an electronic device shown as a user device 300A can capture an image of the object with surrounding environment using a camera of the user device. For example, the user can use a feature of the camera (such as a camera phone application or a digital camera) to easily add any custom additional objects, via an object selector 32A, 32B, 32C, to an object detector by taking and labelling the image (draw a box around the object).

The images labelled are used, as image data, in the disclosed process to, inter-alia, perform custom object detection with automated image augmentation and generation.

When the user selects one of the added objects using an object selector 32A, for example in the user interface of the user device 300A, such as in a graphical user interface, GUI, displayed on display circuitry of the user device (for example, a camera).

The present disclosure proposes, based on the user selection of the object selector, that the user device loads one or more first parameters including a first parameter 12 of a detection model 20 of an object detector according to the chosen object. For example, the one or more first parameters are indicative of an object or an object type, (such as a face, a bird, a car) For example, the first parameter 12 may form part of model parameters 10. For example, the first parameter 12 may be loaded for the entire detection model 20, or in most implementations it may be sufficient to change one or more of the last layers in the detection model 20.

The labelling of the image data may lead to outputting a training data set comprising training images covering the object and/or the object type (possibly a large amount of training images).

The present disclosure proposes an object detection which can be seen as specialized or customized for a type of object. For example, the object detection disclosed herein allows building object detector specialized for a given object, such as your pet, a type of plant, and/or a type of shape.

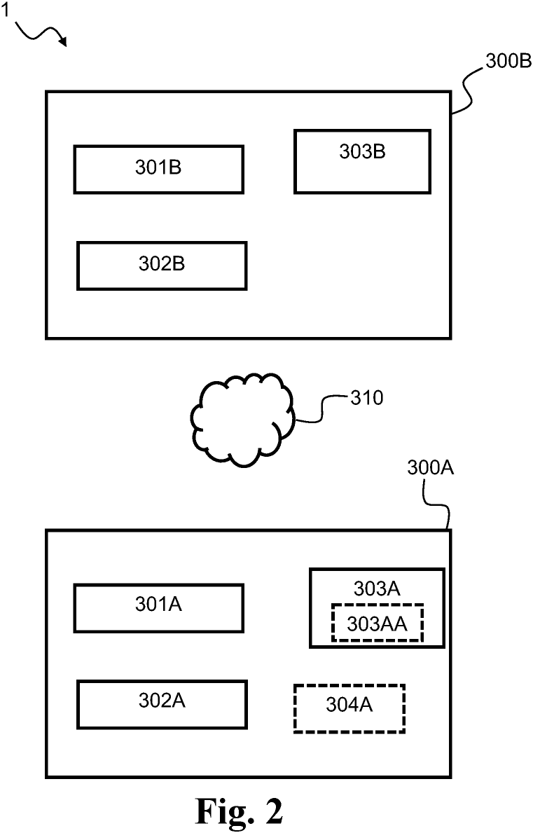

FIG. 2 is a schematic representation illustrating an example of a scenario of object detection. FIG. 2 shows an example system 1 comprising an electronic device 300B according to the disclosure acting as a server device and an electronic device 300A according to the disclosure acting as a user device.

FIG. 2 shows a block diagram illustrating an electronic device 300B according to the disclosure acting as a server device and a block diagram illustrating an electronic device 300A according to the disclosure acting as a user device.

The electronic device 300A acting as a user device may be configured to communicate with the electronic device 300B acting as a server device via a network 310 (such as an external network, for example a wired communication system and/or a wireless communication system).

The electronic device 300A, 300B comprises memory circuitry 301A, 301B, interface circuitry 303A, 303B, and processor circuitry 302A, 302B.

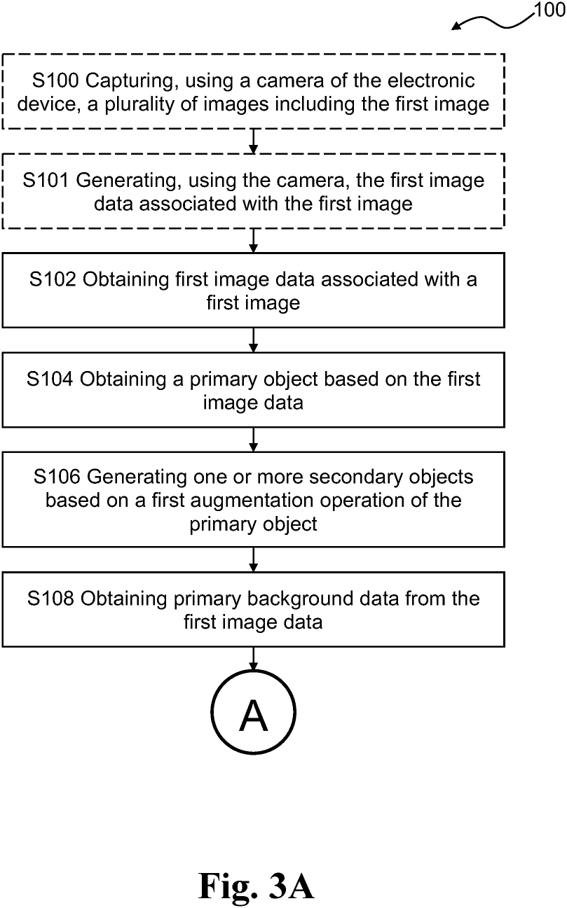

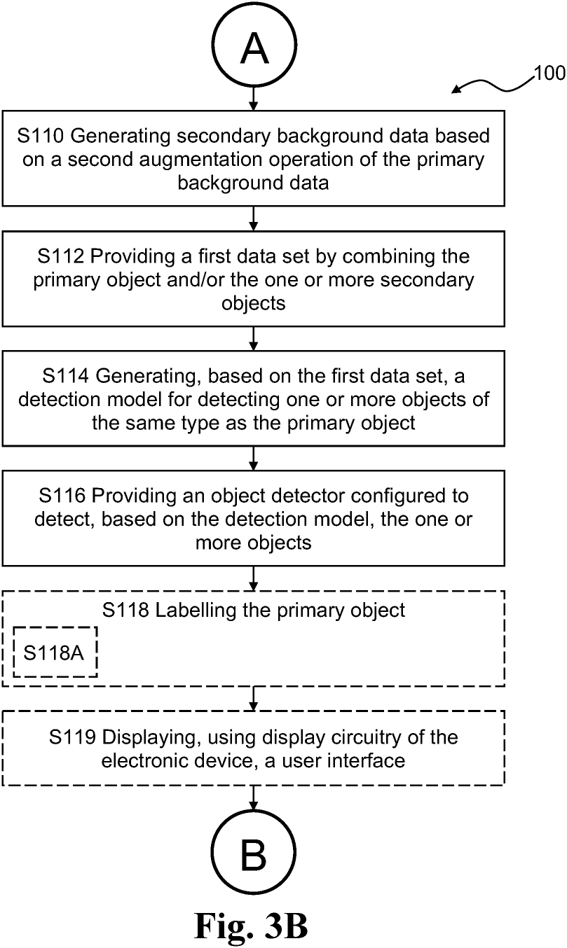

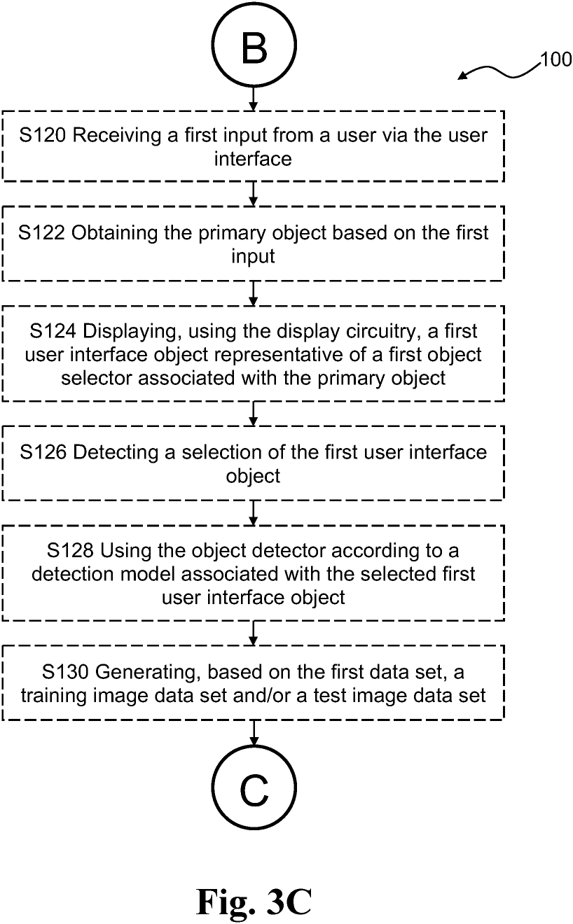

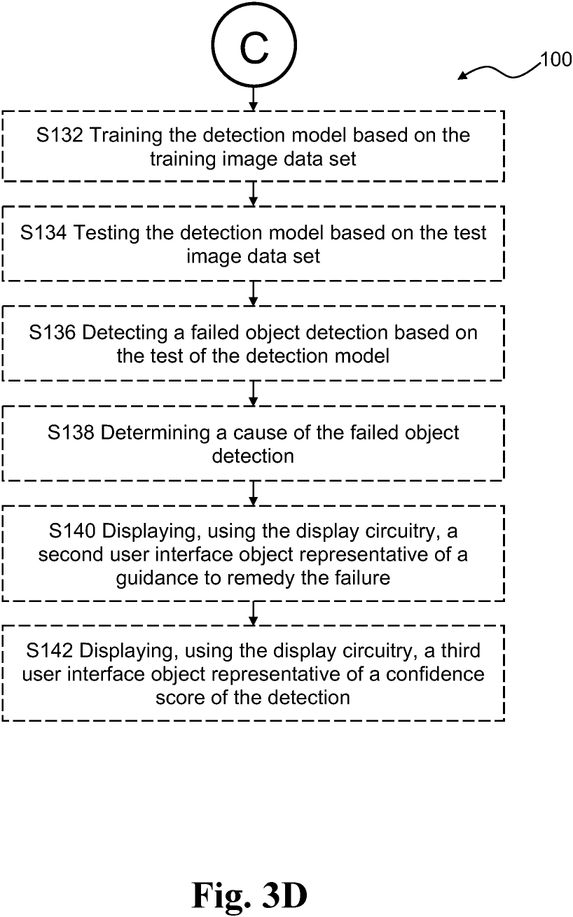

The electronic device 300A, 300B may be configured to perform any of the methods disclosed in FIGS. 3A, 3B, 3C, and 3D. In other words, the electronic device 300A, 300B may be configured for object detection.

The processor circuitry 302A, 302B is configured to obtain (such as via the interface circuitry 303A, 303B and/or from the memory circuitry 301A, 301B) first image data associated with a first image. In other words, the electronic device 300A may be configured to retrieve the first image data associated with the first image from the memory circuitry 301A. In one or more embodiments, the electronic device 300B acting as the server device may be configured to receive the first image and/or the first image data associated with the first image from the electronic device 300A acting as the user device, for example via the network 310.

The first image data may comprise one or more image files (such as one or more image files associated with the first image). The first image data may comprise image data in one or more image formats (such as one or more file types, for example png, bmp, jpeg, jpg, gif, tiff, psd, pdf, eps, ai, indd, raw), and/or one or more pixels associated with the first image and/or metadata associated with the first image. The first image data may comprise image data in one or more data resolution formats (such as one or more colour resolution formats, such as 1 bit colour resolution, 8-bit colour resolution, 12-bit colour resolution, 16-bit colour resolution, 24-bit colour resolution, 32-bit colour resolution, and/or 48-bit colour resolution).

The processor circuitry 302A, 302B is configured to obtain (such as via the interface circuitry 303A, 303B and/or from the memory circuitry 301A, 301B) a primary object based on the first image data. In one or more example electronic devices, the primary object is obtained based on the first image data by extracting the primary object based on the first image data (such as from the first image).

An object disclosed herein may refer an item that may be detectable from an image (such as a object that the object detector may be able to detect, such as trained to detect), such as a captured image or about to be captured. For example, the object may refer to an item generally classified as an object and/or a shape of an item (such as a part of an object, an object of a specific shape). In other words, the object may be denoted as a feature (for example a feature that the object detector may be able to detect, (such as trained to detect) such as a shape). For example, the object may comprise an object such as an animal object (such as representative of a pet of the user, for example a dog, such as a specific dog, a cat, such as specific cat, a bird, such as a specific bird, and/or a horse, such as a specific horse), for example for detecting substantially only that specific animal of the user. The object may comprise a specific type of objects, such as a specific type of animal objects (such as representative of a specific species of an animal type, for example for detecting substantially only a specific bird species), a specific breed of an animal type, for example for detecting substantially only a specific breed of dogs, such as for detecting Labradors only, a specific model of a car, and/or a specific model of shoes. The object may comprise an object such as a type of objects, such as skateboards, for example for detecting skateboards when capturing images and/or to detect skateboards in stored images.

The primary object may comprise an object (such as an object type) that a user wants to be able to detect when capturing images and/or to detect in stored images (such as stored on the electronic device 300A, 300B). For example, the primary object may comprise an object such as an animal object (such as representative of a pet of the user, for example a dog, such as a specific dog, a cat, such as specific cat, a bird, such as a specific bird, and/or a horse, such as a specific horse), for example for detecting substantially only that specific animal of the user. The primary object may comprise a specific type of objects, such as a specific type of animal objects (such as representative of a specific species of an animal type, for example for detecting substantially only a specific bird species), a specific breed of an animal type, for example for detecting substantially only a specific breed of dogs, such as for detecting Labradors only, a specific model of a car, and/or a specific model of shoes. The primary object may comprise an object such as a type of objects, such as skateboards, for example for detecting skateboards when capturing images and/or to detect skateboards in stored images.

The processor circuitry 302A, 302B is configured to generate one or more secondary objects based on a first augmentation operation of the primary object. In one or more example electronic devices, the one or more secondary objects may be seen as one or more representations of the primary object after the first augmentation operation of the primary object.

An augmentation operation disclosed herein may be seen as a transformation operation, such as a blurring operation, a scaling operation, a rotation operation, a histogram equalization, an adaptive histogram equalization (AHE), a contrast limited adaptive histogram equalization (CLAHE), and/or a contrast stretching operation.

In other words, the processor circuitry 302A, 302B may be configured to generate the one or more secondary objects, such as a plurality of secondary object, for example as secondary object images indicative of the primary object after the first augmentation operation. In other words, the processor circuitry 302A, 302B may be configured to create a plurality of secondary objects (such as object images) by feeding the obtained primary object (such as labelled object provided as input) to the first augmentation operation (such as a first augmentation pipeline).

The first augmentation operation may for example comprise one or more of: a blurring operation of the primary object, a scaling operation of the primary object, a rotation operation of the primary object, a histogram equalization, an adaptive histogram equalization (AHE), a contrast limited adaptive histogram equalization (CLAHE), and a contrast stretching operation. For example, when the first image comprises an image of a first bird, the primary object is a first bird object (such as an image of the first bird), then the one or more secondary objects may comprise representations of the first bird object, where the first bird object has been transformed, such as rotated, blurred, scaled up, histogram equalized, adaptive histogram equalized, contrast limited adaptive histogram equalized, and/or contrast stretched. This may provide a plurality of secondary objects. The one or more secondary objects may comprise one or more representations of the primary object that has been through the first augmentation operation. For example, the one or more secondary objects may comprise one or more representations of the primary object that has been through the first augmentation operation such as an augmented animal object (such as representative of a pet of the user that have been augmented through the first augmentation operation, for example a blurred dog object, such as a specific blurred dog image object, a rotated cat object, such as specific rotated cat object image, a scaled up bird object, such as a specific scaled up bird object image, and/or a horse object that have been through a AHE operation, such as a specific horse object image).

The processor circuitry 302A, 302B is configured to obtain (such as via the interface circuitry 303A, 303B and/or from the memory circuitry 301A, 301B) primary background data (such as one or more background images) from the first image data (such as a primary background from the first image). The first image data may comprise the primary object with primary background data. The primary background data may comprise a primary background from the first image. In other words, the processor circuitry 302A, 302B may be configured to extract the primary background data (such as the primary background) from the first image data (such as based on the first image data, for example from the first image). In one or more example electronic devices, the primary background data may comprise one or more other background data (such as obtained from a database with images, such as a database with reference images comprising one or more standard background data, and/or obtained using a statistical method to find images (such as statistical properties of the background and/or structural similarity index, SSIM), such as among a database of stored images, with similar background data as the primary background data). The database with images may be a central database. For example, when the first image comprises an image of the first bird in the tree, then the first bird object may be combined with the one or more other background data (such as a sky background, for representing the first bird object with a sky background, a building background, for representing the first bird object with a building background, and/or a similar tree background, for representing the first bird object with a similar tree background).

The processor circuitry 302A, 302B may be configured to obtain (such as via the interface circuitry 303A, 303B and/or from the memory circuitry 301A, 301B) primary background data (such as one or more background images) from image data other than the first image data (such as image data of an image data collection from a database with images, such as from a camera roll).

The processor circuitry 302A, 302B may be configured to obtain (such as via the interface circuitry 303A, 303B and/or from the memory circuitry 301A, 301B) primary background data (such as one or more background images) from the first image and/or image data other than the first image.

The processor circuitry 302A, 302B is configured to generate secondary background data based on a second augmentation operation of the primary background data.

In one or more example electronic devices, the secondary background data comprise one or more representations of the primary background data after the second augmentation operation of the primary background data.

In other words, the processor circuitry 302A, 302B may be configured to generate the secondary background data, such as a plurality of secondary backgrounds, for example as secondary background images associated with the primary background data (such as indicative of the primary background) after the second augmentation operation. In other words, the processor circuitry 302A, 302B may be configured to create a plurality of secondary backgrounds (such as background images) by feeding the obtained primary background data to the second augmentation operation (such as a second augmentation pipeline).

The second augmentation operation may for example comprise one or more of: a blurring operation of the primary background data, a scaling operation of the primary background data, a rotation operation of the primary background data, a histogram equalization, an adaptive histogram equalization (AHE), a contrast limited adaptive histogram equalization (CLAHE), and a contrast stretching operation. For example, when the first image comprises an image of the first bird in a tree, the primary background data comprises a tree background (such as an image of the tree), then the secondary background data may comprise representations of the tree background, where the tree background have been rotated, blurred, scaled up, histogram equalized, adaptive histogram equalized, contrast limited adaptive histogram equalized, and/or contrast stretched. This may provide a plurality of secondary backgrounds.

The processor circuitry 302A, 302B is configured to provide a first data set by combining the primary object (such as an original object) and/or the one or more secondary objects (such as augmented objects) with the primary background data and/or the secondary background data.

In other words, the processor circuitry 302A, 302B may be configured to generate the first data set, such as the first data set comprising image data indicative of a plurality of images (such as images generated based on one or more combinations of the primary object and/or the one or more secondary objects with the primary background data and/or the secondary background data). In other words, the processor circuitry 302A, 302B may be configured to create the first data set by combining the primary object and/or the one or more secondary objects with the primary background data and/or the secondary background data. For example, the primary object may be combined (such as merging, mixing, uniting, and/or synthesizing) with the one or more generated secondary backgrounds and thereby provide the first data set with a plurality of images where the primary object may be represented in one or more environments (such as settings, such as scenarios, such as situations). For example, when the first image comprises an image of the first bird in the tree, then the first bird object may be combined with the one or more secondary background data (such as a blurred tree background, for representing the first bird object with a blurred tree background, a rotated tree background, for representing the first bird object with a rotated tree background, and/or scaled up tree background, for representing the first bird object with a scaled up tree background).

For example, the one or more secondary objects and/or the primary object may be combined with the generated secondary background data and thereby provide the first data set with a plurality of images where the one or more secondary objects may be represented in one or more environments (such as the one or more secondary objects with different secondary background data, such as one or more different secondary backgrounds). For example, when the primary background data comprises a tree background, then the secondary background data have been generated based on the second augmentation operation of the primary background data such as second augmentation operation of the tree background (for example generating secondary background data, such as one or more secondary backgrounds, such as one or more secondary tree backgrounds, such as a blurred tree background, a rotated tree background, and/or a scales up tree background). The one or more secondary objects and/or the primary object may then be combined with the one or more primary background data and/or the one or more secondary background data, such as one or more secondary backgrounds, such as one or more secondary tree backgrounds, such as a blurred tree background, a rotated tree background, a scales up tree background and/or one or more other background data such as a sky background, a building background, and/or a similar tree background). For example, 100 secondary objects are generated by augmenting the primary object, and the primary background data comprising 10 primary backgrounds may be augmented to get the secondary background data comprising 100 secondary backgrounds, the first data set is provided to comprise for example 100 objects in 100 backgrounds, resulting 100 x 100 combinations.

It may be appreciated that the disclosed technique allows using statistical properties of the background of images and finding similar images from a database (such as a camera roll), to use as input in the background augmentation pipeline (such as data augmentation, augmentor, albumentations).

The processor circuitry 302A, 302B is configured to generate, based on the first data set, a detection model for detecting one or more objects of the same type as the primary object. In other words, the detection model for detecting one or more objects of the same type as the primary object may be configured to detect an object (such as an object type) when capturing images and/or to detect in stored images (such as stored on the electronic device 300A, 300B). The type of object may be indicated by the user. The one or more objects of the same type may comprise objects similar to the primary object, such as objects of the same species, and/or the same kind. For example, when the primary object comprises an object such as an animal object (such as representative of a pet of the user, for example a dog, such as a specific dog, a cat, such as specific cat, a bird, such as a specific bird, and/or a horse, such as a specific horse), the one or more objects of the same type may comprise one or more animal objects of the same type as the animal object comprised in the primary object. For example, when the user wants to detect only a specific breed of dogs, such as for detecting Labradors only, the one or more objects of the same type may substantially only comprise image objects comprising Labradors.

The detection model may comprise an object detection model, such as a first detection model (for example associated with a first type of objects), a second detection model (for example associated with a second type of objects), and/or a third detection model (for example associated with a third type of objects). The detection model may comprise a detection model for each object (such as type of object) that the user wants to detect. The detection model may be based on a machine learning technique, such as one or more of: a neural network (such as convolutional neural network, CNN), and deep learning. In one or more embodiments, the detection model may comprise one or more other machine learning methods (such as machine learning techniques). In other words, the first data set may be used to generate a detection model for detecting one or more objects of the same type as the primary object, for example by using the combination of the primary object and/or the one or more secondary objects with the primary background data and/or the secondary background data.

The detection model may be configured to operate according to one or more first parameters including a first parameter of a detection model (such as loaded in the detection model by the user). For example, the detection model may be configured to operate according to one or more first parameters indicative of an object (such as the primary object) or an object type, (such as a face, a bird, a car).

The processor circuitry 302A, 302B is configured to provide an object detector configured to detect, based on the detection model (such as a detection model stored on the electronic device 300A, 300B, for example on the memory circuitry 301A, 301B), the one or more objects. In other words, the object detector may be configured to detect and/or identify (or recognize) the one or more objects of the same type as the primary object, such as identify the one or more objects (such as one or more other objects of the same type as the primary object) in image data such as data obtained from a camera (such as while the user is capturing an image with the camera) and/or image data from stored images (such as images stored on the electronic device 300A, 300B, such as on the memory circuitry 301A, 301B). The object detector may be seen as a specialized object detector for a type of objects (such as trained, generated, and/or maintained for a given type of objects). The object detector may be seen as a custom object detector for a type of objects (such as trained, generated, and/or maintained for a given type of objects). The object detector may be seen as a personalized object detector for a type of objects (such as trained, generated, and/or maintained for a given type of objects) indicated by a user.

In one or more embodiments, the processor circuitry 302A, 302B may be configured to obtain second image data associated with a second image, and to obtain a second primary object based on the second image data, to generate one or more second secondary objects based on a first augmentation operation of the second primary object; to obtain second primary background data from the second image data; to generate second secondary background data based on a second augmentation operation of the second primary background data; to provide a second data set by combining the second primary object and/or the one or more second secondary objects with the second primary background data and/or the second secondary background data, to generate, based on the second data set, a detection model for detecting one or more objects of the same type as the second primary object; and to provide an object detector configured to detect, based on the detection model, the one or more objects. In such one or more embodiments, the primary object obtained based on the first image data may be denoted as a first primary object, the one or more secondary objects may be denoted as one or more first secondary objects, the primary background data and secondary background data may be denoted as first primary background data, and as first secondary background data respectively. It may be envisaged that the operations performed based on the first image, and/or first image data, may be repeated for a second image and/or second image data. It may be envisaged that the operations performed based on the first image, and/or first image data, may be repeated for a third image and/or third image data. Further, it may be envisaged that the operations performed based on the first image, and/or first image data, may be repeated for a plurality of images and/or image data.

It is an advantage of the present disclosure to enable a user to add specific objects to be detected so as to provide an object detector for detection of the specific objects. In other words, an advantage of the present disclosure is to provide an object detector capable of detecting one specific object (such as a user specific object). Further, an advantage of the present disclosure is that an improved object detector is provided for custom object detection (such as specialized or personalized for the user, for example custom for a user object, such as a dog of the user). In turn, an improved object detector is provided, for example detecting a specific object (such as a specific dog of the user) and not only a generic object (such as a generic dog detector).

In one or more example electronic devices, the electronic device 300A, 300B is configured to label the primary object. For example, the labelling of the primary object may comprise assigning a label to the primary object, such as associate the primary object with first metadata label, such as a first label, a first name, a first category (such as a first category, type, and/or species of object).

In one or more example electronic devices 300A, the interface circuitry 303A comprises display circuitry 303AA configured to display a user interface and to receive user input.

In one or more example electronic devices, the electronic device 300A is configured to receive a first input from a user via the user interface.

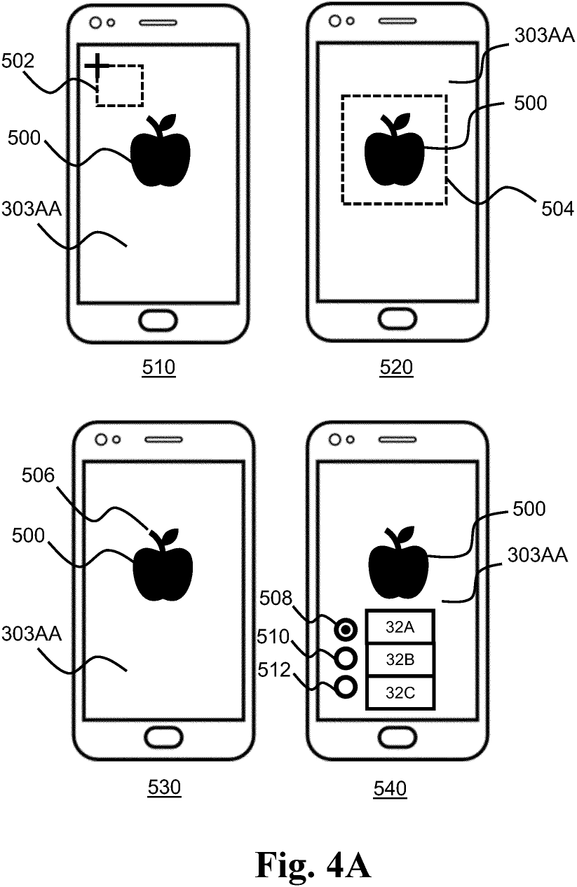

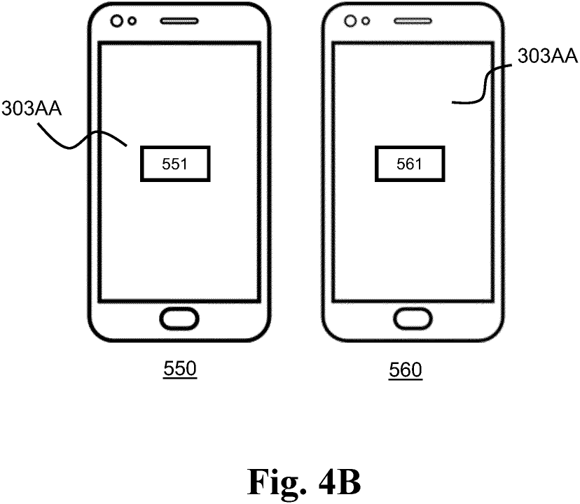

In one or more example electronic devices, the electronic device 300A is configured to obtain the primary object based on the first input. This is illustrated in FIGS. 4A-B.

The first input may comprise one or more of the followings steps (such as steps performed by the user): to add a new object (such as via the user interface, for example via a graphical user interface of the electronic device 300A), for example to add a new object to be detected by the object detector, to name the new object to be detected (for example the user names the type of objects that he/she wants to detect, such as bird_1, Labradors, cars), and to label the primary object in the first image (such as the user labelling the new object to be detected, in the first image).

The display circuitry 303AA of the electronic device 300A may be configured to detect the first input (such as a touch input from the user, for example when the display circuitry 303AA comprises a touch-sensitive display), the first input may comprise a contact on the touch sensitive display. A touch-sensitive display may provide the user interface (such as an input interface) and an output interface between the electronic device 300A and the user. The processor circuitry 302A of the electronic device 300A may be configured to receive and/or send electrical signals from/to touch-sensitive display. A touch-sensitive display may be configured to display visual output to the user. The visual output optionally includes graphics, text, icons, video, and any combination thereof (collectively termed “graphics”). For example, some, most, or all of the visual output may be seen as corresponding to user-interface objects.

The processor circuitry 302 of the electronic device 300A may be configured to display, on the display circuitry 303AA, one or more user interfaces, such as user interface screens, including a first user interface and/or a second user interface (for example illustrated in FIGS. 4A-B). A user interface may comprise one or more, such as a plurality of user interface objects. For example, the first user interface may comprise a first primary user interface object and/or a first secondary user interface object. A second user interface may comprise a second primary user interface object and/or a second secondary user interface object. A user interface object, such as the first primary user interface object and/or the second primary user interface object, may represent an operating state of the base plate.

The electronic device 300A may comprise the display circuitry 303AA configured to display the user interface for receiving the first input. A user interface may comprise one or more user interface objects. A user interface may be referred to as a user interface screen.

A user interface object refers herein to a graphical representation of an object that is displayed on the display circuitry 303AA of the accessory device 300A. The user interface object may be user-interactive, or selectable by the first input (such as a user input). For example, an image (e.g., icon), a button, and text (e.g., hyperlink) each optionally constitute a user interface object. The user interface object may form part of a widget. A widget may be seen as a mini-application that may be used by the user, and created by the user. A user interface object may comprise a prompt, application launch icon, and/or an action menu. An input, such as first input and/or second input, may comprise a touch (e.g. a tap, a force touch, a long press), a and/or movement of contact (e.g. a swipe gesture, e.g. for toggling). The movement on contact may be detected by a touch sensitive surface, e.g. on the display circuitry 303AA of the electronic device 300A. Thus, the display circuitry 303AA may be a touch sensitive display. The first input (such as first user input), such as first input and/or second input, may comprise a lift off. A user input, such as first input and/or second input, may comprise a touch and a movement followed by a lift off.

In one or more example electronic devices, the labelling of the primary object is based on the first input. In one or more electronic devices, the labelling of the primary object is based on the first input, such that the user performs an action of labelling the primary object via the user interface. The labelling may comprise to identify where on the first image the primary object is located (such as an area of the first image where the primary object is, for example a surface of the display circuitry that the user labels to be the area where the primary object is located).

In one or more example electronic devices, the display circuitry 303AA is configured to display a first user interface object representative of a first object selector associated with the primary object.

In one or more example electronic devices, the electronic device 300A is configured to detect a selection of the first user interface, UI object. The selection of the first user object may comprise that the user performs an action of selecting one or more first user interface objects representative of the first object selector associated with the primary object. The selection may comprise detecting a user input on the first UI object, (such as an area of the user interface where the first user interface object is displayed, for example a surface of the display circuitry 303AA that the user selects).

In one or more example electronic devices, the electronic device 300A is configured to use the object detector according to a detection model associated with the selected first user interface object. For example, the user of the object detector according to a detection model associated with the selected first user interface object may comprise a selection of (such as an assignment) a detection model to be used by the object detector (such as a detection model that have been generated and that may be stored on the memory circuitry 301A, 301B).

In one or more example electronic devices, the electronic device 300A, 300B is configured to generate, based on the first data set, a training image data set and/or a test image data set. The generation of the training image data set and/or the test image data set may comprise to split the first data set in (such as into) a training image data set and/or a test image data set. In one or more example electronic devices, the electronic device 300A, 300B is configured to generate, based on the second data set, a training image data set and/or a test image data set.

In one or more example electronic devices, the electronic device 300A, 300B is configured to train the detection model based on the training image data set.

In other words, the training image data set may be used for training the detection model and the test image data set for testing the detection model. For example, the detection model may be trained (such as re-trained, for example with one or more iterations) using the training data set, whereby the detection model may learn to detect one or more objects of the same type as the primary object (such as the new objects that the user wants to detect). In one or more electronic devices, the training of the detection model may be performed on the electronic device 300A acting as the user device and/or the electronic device 300B acting as the server device. For example, depending on the computing resources requirements, the detection model size, the detection model complexity, and/or the amount of data, the training of the detection model may be performed on the electronic device 300A acting as the user device and/or the electronic device 300B acting as the server device. For example, for detection models requiring computing resources due to higher complexity, and/or larger amount of data, the electronic device 300B acting as the server device may be used to perform the training.

In one or more electronic devices, the training image data set (such as one or more training image data sets for one or more detection models) and/or the object detector (such as one or more object detectors for one or more objects to be detected) may be shared between users (such as shared via the server device, via other networks, such as on online market places, for example exchange between user devices and/or server devices), for example if users want to detect the same type of object and thereby share the same object detector.

In one or more example electronic devices, the electronic device 300A 300B is configured to test the detection model based on the test image data set.

For example, the detection model may be tested (such as re-tested, for example with one or more iterations) using the test image data set, whereby the detection model may be tested to assess whether a successful detection of the one or more objects of the same type as the primary object (such as the new objects that the user wants to detect) has been performed by the detection model. In other words, the performance of the detection model may be assessed by testing the model.

In one or more example electronic devices, the electronic device 300A, 300B is configured to detect a failed object detection based on the test of the detection model.

In one or more example electronic devices, the electronic device is configured to determine a cause of the failed object detection.

The detecting of a failed object detection based on the test of the detection model and/or the determining of the cause of the failed object detection may comprise one or more of: extracting images where the object detection has failed, analyse the detected failed object detection (such as one or more failures, for example false positive, false negative, and/or bounding box selection misaligned), analyse the faulty images (such as causes related to capture faults, for example a faulty first image, causes related to the exposure, lightning, illumination, angle, and/or remote object size).

In one or more example electronic devices, the display circuitry 303AA is configured to display a second user interface object representative of a guidance to remedy the failure (such as the detected failed object detection and/or the cause of the failed object detection, for example the detection of one or more failed object detections and/or the causes of the failed object detections).

In one or more electronic devices, the second user interface object may comprise a second user interface object representative of a guidance to remedy the failure, such as an instruction of how to improve the detection model. A guidance to remedy the failure may for example be to indicate to the user via the second user interface object, that more objects in a certain angle needs to be labelled. In one or more electronic devices, the display circuitry 303AA may be configured to display a feedback of an accuracy of the detection model to the user to give an indication that the detection model may need to be improved.

In one or more electronic devices, the electronic device may be configured to determine whether the detection model (such as the model performance, for example automatic model accuracy analysis) is satisfying (such as a performance parameter is above or below a threshold of performance). In one or more electronic devices, the electronic device is configured to stop the training procedure, when it is determined that the detection model is satisfying (such as the test of the detection model shows a satisfying performance, for example the performance parameter is above the threshold of performance).

In one or more electronic devices, the electronic device is configured to provide the second user interface object representative of the guidance to remedy the failure (such as one or more failures, such as based on failure analysis to guide the user of how to remedy the failure, for example by providing more labelled images), when it is determined that the detection model is not satisfying (such as the performance parameter is below the threshold of performance).

In one or more example electronic devices, the display circuitry 303AA is configured to display, a third user interface object representative of a confidence score of the detection. In one or more example electronic devices, the third user interface object may be representative of the confidence score of the detection such as a rating and/or a mean square error.

In one or more example electronic devices, the electronic device 300A comprises a camera 304A configured to capture a plurality of images including the first image and to generate the first image data associated with the first image. In one or more example electronic devices, the electronic device 300A may comprise one or more cameras (such as one or more front cameras and/or one or more rear cameras).

In one or more example electronic devices, the electronic device 300A is a user device. The user device may comprise a mobile device (such as a mobile phone, a smartphone, a cell phone, a tablet, a camera, a photographic equipment, a camcorder, a capturing device, and/or a mobile computer such as a laptop).

In one or more example electronic devices, the electronic device 300B is a server device.

The server device may comprise a server configured to communicate with an electronic device acting as a user device (such as a client device).

The electronic device 300A, 300B is optionally configured to perform any of the operations disclosed in FIG. 3 (such as any one or more of S100, S101, S118, S118A, S119, S120, S122, S124, S126, S128, S130, S132, S134, S136, S138, S140, S142). The operations of the electronic device 300A, 300B may be embodied in the form of executable logic routines (for example lines of code, software programs, etc.) that are stored on a non-transitory computer readable medium (for example, the memory circuitry 301A, 301B) and are executed by the processor circuitry 302A, 302B).

Furthermore, the operations of the electronic device 300A, 300B may be considered a method that the electronic device 300A, 300B is configured to carry out. Also, while the described functions and operations may be implemented in software, such functionality may as well be carried out via dedicated hardware or firmware, or some combination of hardware, firmware and/or software.

The memory circuitry 301A, 301B may be one or more of a buffer, a flash memory, a hard drive, a removable media, a volatile memory, a non-volatile memory, a random access memory (RAM), or other suitable device. In a typical arrangement, the memory circuitry 301A, 301B may include a non-volatile memory for long term data storage and a volatile memory that functions as system memory for the processor circuitry 302A, 302B. The memory circuitry 301A, 301B may exchange data with the processor circuitry 302A, 302B over a data bus. Control lines and an address bus between the memory circuitry 301A, 301B and the processor circuitry 302A, 302B also may be present (not shown in FIG. 2). The memory circuitry 301A, 301B is considered a non-transitory computer readable medium.

The memory circuitry 301A, 301B may be configured to store information (such as information indicative of first image data, the first image, the primary object, the one or more secondary objects, primary background data, secondary background data, the first data set, one or more detection models, and/or the object detector) in a part of the memory.

FIGS. 3A, 3B, 3C, and 3D are flow-charts illustrating an example method 100, performed by an electronic device (such as the electronic device disclosed herein, such as electronic device 300A, 300B of FIGS. 1 and 2), for object detection, according to this disclosure.

The method 100 comprises obtaining S102 first image data associated with a first image. The method 100 comprises obtaining S104 a primary object based on the first image data.

The method 100 comprises generating S106 one or more secondary objects based on a first augmentation operation of the primary object.

The method 100 comprises obtaining S108 primary background data from the first image data.

The method 100 comprises generating S110 secondary background data based on a second augmentation operation of the primary background data.

The method 100 comprises providing S112 a first data set by combining the primary object and/or the one or more secondary objects with the primary background data and/or the secondary background data.

The method 100 comprises generating S114, based on the first data set, a detection model for detecting one or more objects of the same type as the primary object.

The method 100 comprises providing S116 an object detector configured to detect, based on the detection model, the one or more objects.

In one or more example methods, the method 100 comprises labelling S118 the primary object.

In one or more example methods, the method 100 comprises displaying S119, using display circuitry of the electronic device, a user interface.

In one or more example methods, the method 100 comprises receiving S120 a first input from a user via the user interface.

In one or more example methods, the method 100 comprises obtaining S122 the primary object based on the first input.

In one or more example methods, labelling S118 the primary object comprises labelling S118A the primary object based on the first input.

In one or more example methods, the method 100 comprises displaying S124, using the display circuitry, a first user interface object representative of a first object selector associated with the primary object.

In one or more example methods, the method 100 comprises detecting S126 a selection of the first user interface object.

In one or more example methods, the method 100 comprises using S128 the object detector according to a detection model associated with the selected first user interface object.

In one or more example methods, the method 100 comprises generating S130, based on the first data set, a training image data set and/or a test image data set.

In one or more example methods, the method 100 comprises training S132 the detection model based on the training image data set.

In one or more example methods, the method 100 comprises testing S134 the detection model based on the test image data set.

In one or more example methods, the method 100 comprises detecting S136 a failed object detection based on the test of the detection model.

In one or more example methods, the method comprises determining S138 a cause of the failed object detection.

In one or more example methods, the method 100 comprises displaying S140, using the display circuitry, a second user interface object representative of a guidance to remedy the failure.

In one or more example methods, the method 100 comprises displaying S142, using the display circuitry, a third user interface object representative of a confidence score of the detection.

In one or more example methods, the method 100 comprises capturing S100, using a camera of the electronic device, a plurality of images including the first image.

In one or more example methods, the method 100 comprises generating S101, using the camera, the first image data associated with the first image.

In one or more example methods, the method 100 comprises the electronic device is a user device (such as electronic device 300A of FIGS. 1, 2).

In one or more example methods, the method 100 comprises the electronic device is a server device (such as electronic device 300B of FIGS. 1, 2).

FIGS. 4A-B show examples of user interfaces of an electronic device acting as a user device according to the present disclosure.

The electronic device comprises display circuitry configured to display a user interface and to receive user input via the user interface, e.g. user interface 510, 520, 530, 540, 550, 560.

A user may capture an image, such as an image of an apple (for example, an image comprising an object representative of an apple), using the electronic device.

The electronic device is configured to capture the image, such as the first image of the apple and to obtain image data associated with the first image.

A user may select an image, such as an image of an apple (for example, an image comprising an object representative of an apple), from a collection of images using the electronic device.

In user interface 510, the display circuitry displays a user interface object 500 representative of a primary object which is the apple, and a user interface object 502 representative of a selection tool for operating, for example, a bounding box.

For example, the user provides a first input 504, for example using the selection tool represented by user interface object 502.

The electronic device is configured to receive a first input from a user via the user interface, e.g. user interface 510, 520, 530. The electronic device is configured to obtain the primary object 500 based on the first input 504 in user interface 520. The first input 504 allows a selection of a box around the primary object: the apple.

The electronic device is configured to label the first primary object 500 based on the first input 504.

User interface 530 shows the primary object 500 as an apple and a user interface object 506 representative of a selection tool for operating, for example, a bounding box, which follows the contour of the primary object 500. The electronic device is configured to obtain the primary object 500 based on the first input 506 in user interface 530. The first input 506 allows a selection of a box around the primary object 500: the apple.

For example, the user provides a first input 504, for example using user interface object 506.

The user selects the primary object 500 based on the first input 504.

In user interface 540, the display circuitry displays the user interface object 500 representative of the primary object 500, and a first user interface object 508 representative of a first object selector 32A associated with the first primary object 500.

The user is able to select the first object selector 32A by entering an input (such as a touch input) on the first user interface object 508, amongst the other user interface objects 510, 512 representative of other object selectors 32B, 32C respectively.

The electronic device is configured to detect a selection of the first user interface object 508 and use the object detector according to a detection model associated with the selected first user interface object 508. In other words, the user can benefit from the use of the object detector according to a detection model by selecting of the first user interface object 508 (for example by associating the first object selector 32A with the first primary object 500).

In user interface 550, the display circuitry displays a second user interface object 551 representative of a guidance to remedy the failure. The second user interface object 551 may comprise a second user interface object representative of a guidance to remedy the failure, such as an instruction of how to improve the detection model. A guidance to remedy the failure may for example be to indicate to the user via the second user interface object 551, that more objects in a certain angle needs to be labelled. In one or more electronic devices, the display circuitry 303AA may be configured to display a feedback of an accuracy of the detection model to the user to give an indication that the detection model may need to be improved. The detection model may for example be improved with an increased number of images (for example an increased number of labelled objects). In one or more example electronic devices, a user feedback may improve the detection model (for example by providing improved output and accurate labelling for providing “better” images for the detection model.

In user interface 560, the display circuitry displays a third user interface object 561 representative of a confidence score of the detection. The third user interface object 561 may comprise a third user interface object representative of a confidence score of the detection such as a rating and/or a mean square error of the detection.

Embodiments of electronic devices and methods according to the disclosure are set out in the following items:
Item 1. An electronic device (300A, 300B) comprising:
   memory circuitry (301A, 301B);
   interface circuitry (303A, 303B); and
   processor circuitry (302A, 302B);
   wherein the processor circuitry (302A, 302B) is configured to:
   obtain first image data associated with a first image,
   obtain a primary object based on the first image data;
   generate one or more secondary objects based on a first augmentation operation of the primary object;
   obtain primary background data from the first image data;
   generate secondary background data based on a second augmentation operation of the primary background data;
   provide a first data set by combining the primary object and/or the one or more secondary objects with the primary background data and/or the secondary background data;
   generate, based on the first data set, a detection model for detecting one or more objects of the same type as the primary object; and
   provide an object detector configured to detect, based on the detection model, the one or more objects.
Item 2. The electronic device according to item 1, wherein the electronic device (300A, 300B) is configured to label the primary object.
Item 3. The electronic device according to any of the previous items, wherein the interface circuitry (303A) comprises display circuitry (303AA) configured to display a user interface and to receive user input;
   wherein the electronic device (300A) is configured to receive a first input from a user via the user interface,
   wherein the electronic device (300A) is configured to obtain the primary object based on the first input.
Item 4. The electronic device according to item 3, wherein the labelling of the primary object is based on the first input.
Item 5. The electronic device according to any of items 3-4, wherein the display circuitry (303AA) is configured to display a first user interface object representative of a first object selector associated with the primary object;
   wherein the electronic device (300A) is configured to:
      detect a selection of the first user interface object; and
      use the object detector according to a detection model associated with the selected first user interface object.
Item 6. The electronic device according to any of the previous items, wherein the electronic device (300A, 300B) is configured to generate, based on the first data set, a training image data set and/or a test image data set.
Item 7. The electronic device according to item 6, wherein the electronic device (300A, 300B) is configured to train the detection model based on the training image data set.
Item 8. The electronic device according to any of the previous items as dependent on item 6, wherein the electronic device (300A, 300B) is configured to test the detection model based on the test image data set.
Item 9. The electronic device according to any of the previous items as dependent on item 8, wherein the electronic device (300A, 300B) is configured to
   detect a failed object detection based on the test of the detection model; and
   determine a cause of the failed object detection.
Item 10. The electronic device according to item 9, wherein the display circuitry (303AA) is configured to display a second user interface object representative of a guidance to remedy the failure.
Item 11. The electronic device according to any of items 9-10, wherein the display circuitry (303AA) is configured to display, a third user interface object representative of a confidence score of the detection.
Item 12. The electronic device according to any of the previous items, the electronic device (300A) comprises a camera configured to capture a plurality of images including the first image and to generate the first image data associated with the first image.
Item 13. The electronic device according to any of the previous items, wherein the electronic device (300A) is a user device.
Item 14. The electronic device according to any of items 1-2 and 6-9, wherein the electronic device (300B) is a server device.
Item 15. A method, performed by an electronic device, for object detection, the method comprising:
   obtaining (S102) first image data associated with a first image;
   obtaining (S104) a primary object based on the first image data;
   generating (S106) one or more secondary objects based on a first augmentation operation of the primary object;
   obtaining (S108) primary background data from the first image data;
   generating (S110) secondary background data based on a second augmentation operation of the primary background data;
   providing (S112) a first data set by combining the primary object and/or the one or more secondary objects with the primary background data and/or the secondary background data;
   generating (S114), based on the first data set, a detection model for detecting one or more objects of the same type as the primary object; and
   providing (S116) an object detector configured to detect, based on the detection model, the one or more objects.
Item 16. The method according to item 15, the method comprising:
   labelling (S118) the primary object.
Item 17. The method according to any of items 15-16, the method comprising:
   displaying (S119), using display circuitry of the electronic device, a user interface
   receiving (S120) a first input from a user via the user interface; and
   obtaining (S122) the primary object based on the first input.
Item 18. The method according to item 17, wherein labelling (S118) the primary object comprises labelling (S118A) the primary object based on the first input.
Item 19. The method according to any of items 17-18, the method comprising:
   displaying (S124), using the display circuitry, a first user interface object representative of a first object selector associated with the primary object;
   detecting (S126) a selection of the first user interface object; and
   using (S128) the object detector according to a detection model associated with the selected first user interface object.
Item 20. The method according to any of items 15-19, the method comprising:
   generating (S130), based on the first data set, a training image data set and/or a test image data set.
Item 21. The method according to item 20, the method comprising:
   training (S132) the detection model based on the training image data set.
Item 22. The method according to any of items 20-21, the method comprising:
   testing (S134) the detection model based on the test image data set.
Item 23. The method according to item 22, the method comprising:
   detecting (S136) a failed object detection based on the test of the detection model; and
   determining (S138) a cause of the failed object detection.
Item 24. The method according to item 23, the method comprising:
   displaying (S140), using the display circuitry, a second user interface object representative of a guidance to remedy the failure.
Item 25. The method according to any of items 23-24, the method comprising:
   displaying (S142), using the display circuitry, a third user interface object representative of a confidence score of the detection.
Item 26. The method according to any of items 15-25, the method comprising:
   capturing (S100), using a camera of the electronic device, a plurality of images including the first image; and
   generating (S101), using the camera, the first image data associated with the first image.
Item 27. The method according to any of items 15-26, wherein the electronic device is a user device.
Item 28. The method according to any of items 15-16 and 20-23, wherein the electronic device is a server device.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-4B comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. An electronic devicecomprising:
memory circuitry;
interface circuitry; and
processor circuitry;
wherein the processor circuitryis configured to:
obtain first image data associated with a first image,
obtain a primary object based on the first image data;
generate one or more secondary objects based on a first augmentation operation of the primary object;
obtain primary background data from the first image data;
generate secondary background data based on a second augmentation operation of the primary background data;
provide a first data set by combining the primary object and/or the one or more secondary objects with the primary background data and/or the secondary background data;
generate, based on the first data set, a detection model for detecting one or more objects of the same type as the primary object; and
provide an object detector configured to detect, based on the detection model, the one or more objects of the same type as the primary object,
wherein the electronic device is configured to generate, based on the first data set, a training image data set and/or a test image data set.

2. The electronic device according to claim 1, wherein the electronic deviceis configured to label the primary object.

3. The electronic device according to claim 1, wherein the interface circuitry comprises display circuitry configured to display a user interface and to receive user input;
wherein the electronic device is configured to receive a first input from a user via the user interface,
wherein the electronic device is configured to obtain the primary object based on the first input.

4. The electronic device according to claim 3, wherein the labelling of the primary object is based on the first input.

5. The electronic device according to claim 4, wherein the display circuitry is configured to display a first user interface object representative of a first object selector associated with the primary object;
wherein the electronic device is configured to:
detect a selection of the first user interface object; and
use the object detector according to a detection model associated with the selected first user interface object.

6. (canceled)

7. The electronic device according to claim 1,
wherein the electronic device is configured to train the detection model based on the training image data set.

8. The electronic device according to claim 1, wherein the electronic device is configured to test the detection model based on the test image data set.

9. The electronic device according to claim 8, wherein the electronic device is configured to:
detect a failed object detection based on the test of the detection model; and
determine a cause of the failed object detection.

10. The electronic device according to claim 9, wherein the display circuitryis configured to display a second user interface object representative of a guidance to remedy the failure.

11. The electronic device according to claim 9, wherein the display circuitry is configured to display, a third user interface object representative of a confidence score of the detection.

12. The electronic device according to claim 1, the electronic device comprises a camera configured to capture a plurality of images including the first image and to generate the first image data associated with the first image.

13. The electronic device according to claim 1, wherein the electronic device is a user device.

14. The electronic device according to claim 1, wherein the electronic device is a server device.

15. A method, performed by an electronic device, for object detection, the method comprising:
obtaining first image data associated with a first image;
obtaininga primary object based on the first image data;
generatingone or more secondary objects based on a first augmentation operation of the primary object;
obtainingprimary background data from the first image data;
generatingsecondary background data based on a second augmentation operation of the primary background data;
providinga first data set by combining the primary object and/or the one or more secondary objects with the primary background data and/or the secondary background data;
generating, based on the first data set, a detection model for detecting one or more objects of the same type as the primary object; and
providingan object detector configured to detect, based on the detection model, the one or more objects of the same type as the primary object.

16. The method according to claim 15, the method comprising:
labellingthe primary object.

17. The method according to claim 15, the method comprising:
displaying, using display circuitry of the electronic device, a user interface
receivinga first input from a user via the user interface; and
obtainingthe primary object based on the first input.

18. The method according to claim 17, wherein labelling the primary object comprises labellingthe primary object based on the first input.

19. The method according to claim 17, the method comprising:
displaying, using the display circuitry, a first user interface object representative of a first object selector associated with the primary object;
detectinga selection of the first user interface object; and
usingthe object detector according to a detection model associated with the selected first user interface object.

20. The method according to claim 15, the method comprising:
generating, based on the first data set, a training image data set and/or a test image data set.

21. The method according to claim 20, the method comprising:
trainingthe detection model based on the training image data set.

22-28. (canceled)
